(19) United States
(12) Patent Application Publication
(10) Pub. No.: US 2004/0013033 A1
(43) Pub. Date: Jan. 22, 2004

(54) Horizontal mixer with a tall design

(76) Inventor: Hartmut Haverland, Paderborn (DE)

Correspondence Address: SCHWEITZER CORNMAN GROSS & BONDELL LLP, 292 MADISON AVENUE - 19th FLOOR, NEW YORK, NY, 10017, US

(21) Appl. No.: 10/620,537

(22) Filed: Jul. 16, 2003

(30) Foreign Application Priority Data
Jul. 20, 2002 (DE) 102 33 785.3

(51) Int. Cl. B01F 7/02

(52) U.S. Cl. 366/192; 366/325.1

(57) ABSTRACT

The invention relates to a mixing device (1) with a drum (3, 4) which can receive ingredients, the drum (3, 4) comprising a cylindrical vessel (4), and mixing means, which are able to mix the ingredients in the interior of the cylindrical vessel (4), the mixing means being arranged rotatably about a mixing spindle (6), and is characterised in that the longitudinal axis of the cylindrical vessel (4) extends horizontally and the internal diameter of the drum (3, 4) is larger than the internal length of the drum (3, 4).

The compact design according to the invention makes it possible to provide a mixer with which total emptying is guaranteed, which can be used in the food industry and with which products which are mixed can be changed easily.

Horizontal mixers and vertical mixers are known from prior art. The spindle that is fitted with the mixing tooling extends horizontally in a horizontal mixer. In a vertical mixer the aforementioned spindle extends vertically.

A horizontal mixer is able to mix substances better than a vertical mixer. The reason for this is that the liquids and solids, which are to be mixed, are thrown upwards by the mixing tooling. This creates larger surfaces. An improved mixing process is the result. The product bed is larger in relation to volume in a horizontal mixer.

The mixing tools in a mixer must keep a distance to the wall so that they do not scrape against the wall and in order to balance out irregularities in the geometry of the wall or of the mixing tool. The typical distance in a vertical mixer is 2 mm.

In a horizontal mixer the distance between a mixer wall and a mixing tool is approximately 3-5 mm. The reason for this is that the spindle in a long mixer sags. This leads to the necessity of adhering to the aforementioned larger distance. It is also necessary to adhere to a larger distance from a construction point of view. In particular the distance between the base and the mixing tooling in a vertical mixer is only a few millimetres as stated above because it has a flat base. From a technical point of view the precise distance is easier to attain. This distance has an effect on the residue remaining in the mixer when it is emptied.

The base, that is a section of the tubular mixing drum located below, of a horizontal mixer is curved. Therefore the need to adhere to the larger distance is determined here by the type of construction.

When a vertical mixer is emptied the mixing tooling scrapes along the base and thus contributes to its being totally or almost totally emptied. Typically about 1 0/00 remains, for example 10 litres from a volume of 2,000 litres.

The mixing tooling contributes less effectively to the emptying process in a horizontal mixer because the distance is larger here, as illustrated above. Furthermore the surface area of the base is larger in relation to the volume so that for this reason as well more material remains in the mixer when it is emptied.

In addition the horizontal mixer has the disadvantage that it is long, so that a correspondingly long emptying vessel is necessary if the base is to be opened along the full length. This is usually necessary in order for successful emptying to be achieved.

If it is not possible for technical reasons to have a long base that opens completely then the mixed material is emptied via pipes. In such a case a maximum of 2% typically remains in relation to mixer volume, for example 30 litres in relation to a mixer volume of 2,000 litres, because the residue has to flow out in the axial.

The emptying process works very well with a horizontal mixer if the base can be opened along the whole length of the mixer.

A long vessel is a disadvantage if it has to be used to receive mixed materials which are difficult to handle. In particular it cannot be used as a conveying device. Shorter compact vessels should be used in this instance.

The horizontal mixer known from prior art cannot therefore be used with a base that can be opened along the whole length if the products to be mixed have to be changed over rapidly. In this case it is necessary to use the collecting container underneath the mixing vessel as a conveying vessel at the same time. The problem of cleaning is transferred in this way from the mixer to the vessel when long vessels are used. The cleaning of a long vessel is more time consuming than that of a shorter one. Therefore shorter conveying vessels are necessary. Mixers with pipes would have to be used then. In this case the problem of ineffective emptying occurs. Such a case becomes especially problematic when for example a dark spice is mixed first and then a light spice afterwards.

In prior art long horizontal mixers are preferably used which have a relatively small diameter in relation to the length, because otherwise variations from the cylindrical shape could occur. It would then be a case of a vessel with a slightly oval diameter. The distance between the mixing tools and the mixer wall would have to be enlarged still further. The aforementioned disadvantages would result from this.

The object of the invention is to provide a mixer in which total emptying is guaranteed in the aforementioned sense, which can be used in the food industry and in which products which are to be mixed can be changed easily.

The object of the invention is achieved by a mixer with the characteristics of claim 1. Advantageous configurations will emerge from the sub-claims.

An advantageous application emerges from the accompanying claim.

The mixer has a design that differs from prior art in order to solve the aforementioned problem.

In prior art horizontal mixers are typically used which have a diameter of between 500 and 2,000 mm. The length of the mixer is typically two to three times the diameter. According to the invention the diameter is greater than the length. The volume of the mixer according to the invention is typically at least 300 litres. A typical upper limit is 8,000 litres.

In order to ensure that the mixer has a cylindrical shape, the vessel is provided with reinforcing rings. The reinforcing rings are to be found outside the space, so that the latter do not disturb the mixing process and provide a dead space.

It is particularly necessary in the food industry to inspect the mixer from the inside. With rapid changeovers in products it is also necessary to be able to clean the machine from the inside. The necessity to be able to get into the interior of the mixer also occurs in these cases.

In prior art a door is provided on horizontal mixers, which is typically pivoted upwards or downwards in order to get into the interior of the mixer. When very large diameters are provided the door can only be kept relatively small. On the one hand this is because of space, since the door cannot be opened higher than the ceiling of the room. On the other hand this is because of handling, since correspondingly large doors become very heavy and may only be able to be opened with hydraulic support systems. In the present case a door is utilised in an embodiment of the invention, which is pivoted laterally, therefore about a vertical axis. The door can be handled better as a result since no mass has to be lifted. The space which is necessary in order to open the door can be kept small in a vertical direction. A door can be selected which is just large enough to enable easy access into the interior.

As a result of the large diameter provided it is possible to fix a flat plate in the upper region instead of using a filling pipe. The plate is screwed to the vessel or connected to it in another detachable way. Varying diameters can be provided in the plate according to requirements for filling with the ingredients. In this way the mixer according to the invention is more variable in comparison to prior art. In prior art fixed pipes are welded to the drum in order to be able to fill the mixer vessel with products from above.

The lower plate, via which the mixer is emptied, has the same curve, therefore the same radius, as the mixer vessel, so that in a closed state a round vessel is formed with a uniformly round diameter. The roundness is necessary in order for the tools to come close to the walls.

It is possible to perform rapid changeovers of product with the mixer according to the invention. Typically 3 to 4 batches are envisaged per hour in the food industry, as for example in the blending of spices. After that a product changeover takes place. As a result this means that the product is changed several times every hour. The mixer according to the invention is arranged in such a way that this can be handled easily. The reason for this is that the mixer on the one hand can be entered via the door according to the invention. Furthermore comparatively short vessels can be used according to the invention underneath the mixer for emptying. These can be exchanged rapidly and used for conveying.

Advantages of the invention are simple access for inspection, cleaning and maintenance. This was achieved through the large inspection door.

An axial conveyance of the ingredients takes place inside a mixer for mixing purposes, as well as a radial conveyance. The radial conveyance is carried out by the shovels, which throw the ingredients upwards out of the product bed. In order to carry out an axial conveyance the shovels are set obliquely for example. Via additional obliquely set surfaces, plates, etc, an axial conveyance is introduced as an alternative or in addition.

By conveyance it is not just to be understood that the ingredients are conveyed in a particular direction, for example preferably to the right. It also means in particular that the ingredients are conveyed sometimes in one direction and sometimes in the other direction for mixing purposes, and are therefore mixed.

Axial conveyance of the ingredients is relatively time consuming in comparison with conveyance in a radial direction. The mixing times are therefore extended the longer the mixer is. This is particularly problematic when the ingredients are added at various points of the horizontal mixer via filling pipes distributed along the length of the mixer, since each pipe can introduce a different ingredient.

Therefore the ingredients more or less have to be added centrally due to the compact design according to the invention. In addition to this the conveyance in an axial direction is significantly reduced relative to the conveyance in a radial direction. The mixer according to the invention therefore also shortens the mixing times.

Due to the long design up to twelve shovels are typically needed in prior art, which are arranged about the spindle of the mixing tool. With the mixer according to the invention the number of shovels can be at least halved. This results in a smaller amount of fixed equipment as well as a reduction in wearing parts and replacement parts.

The end walls can be arranged flat. However the use of an outwardly conical end face is advantageous, as is the use of a curved plate. In this way space is provided at the side. Through this the diameter can be advantageously reduced somewhat in size in relation to a mixing vessel that is provided with flat side walls and end walls, with same total volume being achieved. The transition between the inner wall of the cylindrical vessel to the inner wall of the end wall should be steeper than 40 degrees (angle of flow). Through this the ingredients are guaranteed to again reach the actual mixing region and therefore be mixed.

A dished head could also be considered, used as an end wall. This is however relatively expensive and furthermore it is less suitable, as the required steep angle would be missing.

In an advantageous embodiment of the invention, an end wall is made movable, to allow people to clean the interior of the mixer. The end wall can for example be hinged and therefore allow access to the interior of the housing. Since the end face is the same size as the cylindrical vessel the interior of the mixer and the mixing means are easily and comfortably accessible, also when the mixing means are being repaired. Because of the compact size of the mixer with its relatively short length according to the invention, it is sometimes not necessary for people to enter into the mixer at all, since all of the inner surfaces can be reached comfortably from the outside. If the mixer spindle is only fixed to one of the end walls the other end wall can be swung open. The short design makes it possible to have a mixing spindle that is only fixed on one side and extends freely into the drum. Conventional horizontal mixers need the mixer spindle to be fixed on both sides in order to prevent it from sagging. It is preferably provided that the mixer spindle is detachably fixed, that is mounted, to the movable end wall which serves as doors, in order to guide the mixing means more exactly in relation to the inner walls of the mixer. The bearing of this end wall therefore operates substantially in a vertical direction and the mixing spindle can be pulled out of the bearing in an axial direction.

The shovel shape, which is known from published specification DE 197 06 364 A1, is used preferably for the mixing tool. Mixing tool surfaces, which are T-shaped, are provided on the spindle of this mixing tool. It has been proven that these function particularly well if the T-shape is especially long. By this it is to be understood that the letter “T” is particularly tall. The mixing tool surface 17 according to the aforementioned document can then be particularly pronounced. This results in improved mixing times.

Furthermore the mixing tool, which is known from document DE 197 43 923 C2 also comes into consideration. It is therefore not necessary to use a particular mixing tool in order to be able to mix with the mixer according to the invention. For the abovementioned reasons it is however preferable to use the mixing tool from the document mentioned first.

The product residue after emptying was minimised by extending the emptying opening more or less to the size or the whole length of the drum base. The opening was not made so large however that an immediate total emptying takes place, which would require a bunker located underneath with the same volume. A suitable measure would be that the width of the opening could be reduced accordingly and flexibly, while the length remained constant. As a result the different discharge or flowing properties of various ingredients can be reacted to suitably and flexibly.

The mixer is adapted in design and choice of components to the requirements of the food and pharmaceutical industries. It can be adapted in quality but also in cost.

In the feeds industry, for example, cheaper materials such as steel can be used. In the pharmaceutical industry stainless steels are used. The use of steel with the tool numbers 4571 and 4541 is preferred.

The following is a description of the invention, which is shown in the accompanying drawings, in which:

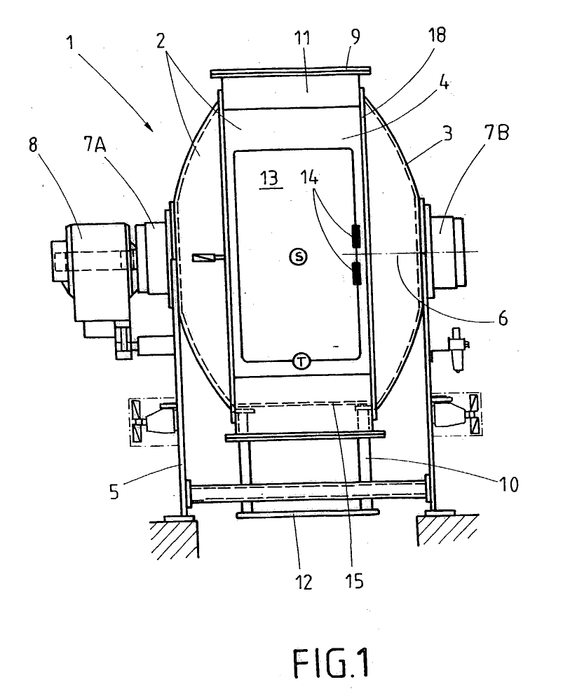

FIG. 1 is a diagrammatical side view of a horizontal mixer according to the invention,

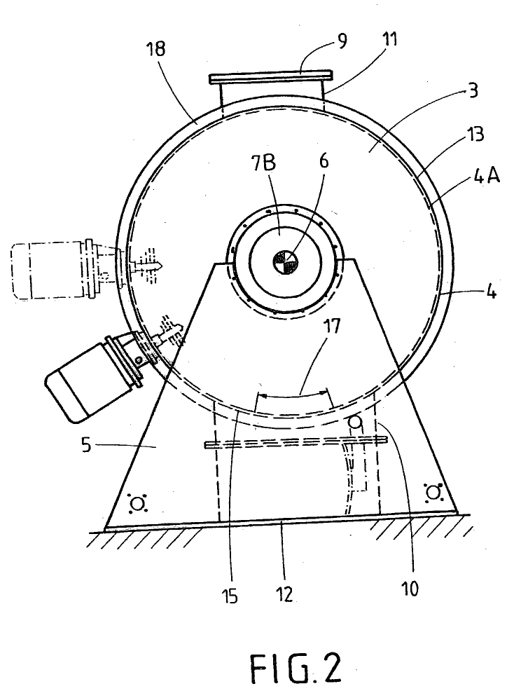

FIG. 2 is the horizontal mixer from FIG. 1 in side view from the right, and

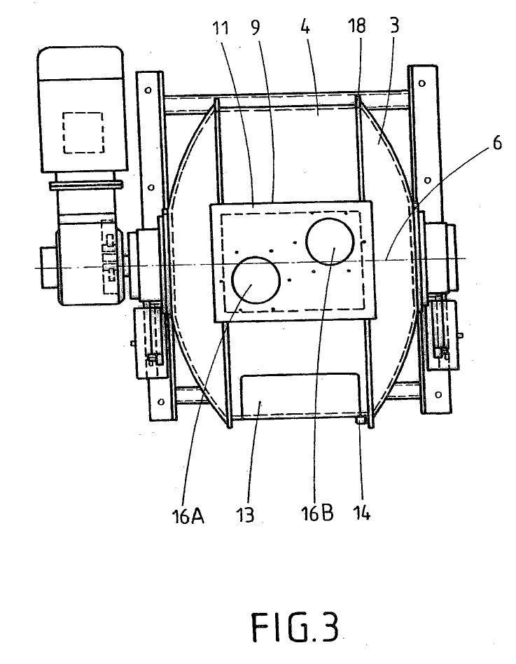

FIG. 3 is a plan view of the mixer from FIG. 1.

In FIG. 1 an embodiment of the horizontal mixer according to the invention is shown diagrammatically. The mixer volume of the mixer 1 comprises a drum 2 for ingredients, which are not shown. It comprises substantially a cylindrical vessel 4, the central spindle 6 of which is located horizontally, and two end walls 3, which close the vessel 4 off on the right and the left. The curved end walls have two bearings 7a, 7b on their exterior ends for the spindle 6 of the mixing means and mixing tools, which are not illustrated. Known mixing tools consist of shovels and conveying plates, which are arranged radially about the spindle 6 of the mixing tool. The drive 8 for the mixing tool is arranged outside the drum 2 in the region of the left bearing 7a. The mixer 1 is fixed to the ground on foundations via two feet 5.

According to the invention the diameter of the mixer is greater than its length, the internal diameter of the cylindrical vessel in the embodiment being 1,600 mm and its width being 700 mm. This is preferably the same for the width as measured between the curved end faces 3.

It may be enough incidentally if the mixing tool, which is not illustrated, only operates in a region inside the cylindrical vessel 4, i.e. it does not rotate inside the space created by the curved end walls 3. It should also be noted that the curved end wall 3 is arranged at an angle a of 40° at the transition to the cylindrical vessel 4. Material which is thrown up into the space of the curved end wall 3 by the mixing tooling can be mixed in this region and falls owing to gravity along the curved end wall 3, the angle of which is greater than 40° at every point, reliably in the direction of the drum base of the vessel 4, where it can be reached again by the mixing tool.

A door 13 is provided in the cylindrical wall of the vessel 4, which door is adapted to the contours of the interior wall 4a of the cylindrical vessel 4. According to the invention the door 13 can be swung open horizontally on hinges 14, so that it does not have to be opened as in prior art upwards or downwards by the use of force. An access opening of for example 600×1000 mm is thereby provided in contrast to prior art, which makes it comfortable to enter. Smaller access holes are less acceptable to workers, so that the interior of the mixer is sometimes not cleaned for reasons of comfort.

The mixer space is filled and emptied via an upper connection part 11 and an emptying connector 10, the geometry of which is shown in FIG. 2.

The side view in FIG. 2 shows that the cylindrical vessel 4 contains a rectangular recess in the upper region, which recess is extended upwards via a vertical connection piece 11. The connecting piece 11 is closed to the above via a rectangular flat plate 9. The plate 9 has openings 16a, 16b, illustrated in FIG. 3, which are connected, for example by welding, to filling pipes, which are not illustrated, for the introduction of the ingredients.

The emptying connector 10 is provided in the region of the base 15 of the mixer. The base is to be opened in the region of a section 17 for the purpose of emptying, the lower door 17 being adapted to the inner geometry of the cylindrical vessel 3 in such a way that the mixing tooling can normally operate along the inner wall 4a of the vessel and the lower door.

The mixed ingredients then leave the mixing device via the outlet 12, conveying and collecting vessels being provided underneath the horizontal mixer or the outlet 12.

The reinforcement ring 9 is connected to the exterior wall of the cylindrical vessel 4 and ensures a round shape of the vessel. A provision outside is preferred so as to not reduce the space inside the mixer. Without the reinforcement ring the drum could deform, for example it could adopt an oval shape due to its deadweight.

Finally the view in FIG. 3 shows the advantages of the upper flat plate 9, which is simply screwed or otherwise detachably connected to the connecting piece 11 in the embodiment. This has the advantage, that the plate 9 can be exchanged if necessary, for example if three such openings are needed as filling pipes and no longer two openings 16a, 16b, because of other work. The filling pipes are frequently welded direct to the exterior wall of the cylindrical vessel 4 in prior art, so that a changeover of parts is very time consuming, since the lower edge of the pipe must not be allowed to extend downwards into the mixer space. It is to be noted furthermore that the two neighbouring filling pipe openings are so close together that the ingredients flowing in in an axial direction of the mixer spindle blend together by themselves to a large extent. Therefore concentrations of the various ingredients do not form at the beginning after filling, as is the case with the horizontal mixers of long design in prior art, in which the ingredients have to be mixed in an axial direction, which is costly.

1. Mixing device (1) with a drum (3, 4) which can receive ingredients, the drum (3, 4) comprising a cylindrical vessel (4), and mixing means, which are able to mix the ingredients in the interior of the cylindrical vessel (4), the mixing means being arranged rotatably about a mixing spindle (6), characterised in that the longitudinal axis of the cylindrical vessel (4) extends horizontally.

2. Mixing device according to claim 1, characterised in that the longitudinal axis of the cylindrical vessel (4) and the mixer spindle (6) extend coaxially.

3. Mixing device according to claim 1 or 2, characterised in that the internal diameter (4A) of the drum (3, 4) is greater than the internal length of the drum.

4. Mixing device according to any of the preceding claims, characterised in that the internal diameter of the cylindrical vessel (4) is greater than the length of the vessel (4).

5. Mixing device according to any of the preceding claims, characterised in that reinforcement rings (18) are provided on the drum (3, 4) or on the vessel (4).

6. Mixing device according to any of the preceding claims, characterised in that the reinforcement rings (18) are provided on the exterior of the drum (3, 4).

7. Mixing device according to any of the preceding claims, characterised in that the cylindrical vessel (4) has an access opening, which can be sealed by an inserted door (13), the door being laterally hinged, in particular about a substantially vertically extending axis.

8. Mixing device according to any of the preceding claims, characterised in that the access opening has such dimensions as to allow easy access for persons into the interior of the drum (3, 4).

9. Mixing device according to any of the preceding claims, characterised in that a flat plate (9) which can be fitted with filling pipes for the ingredients is provided on the upper region of the vessel (4).

10. Mixing device according to any of the preceding claims, characterised in that the flat plate (9) is detachably connected to the vessel, in particular screwed to it.

11. Mixing device according to any of the preceding claims, characterised in that holes (16a, 16b) with different sized diameters for the introduction of the ingredients are provided in the flat plate (9).

12. Mixing device according to any of the preceding claims, characterised in that the vessel can be emptied in the lower region via a lower opening (at 17).

13. Mixing device according to any of the preceding claims, characterised in that the lower opening (at 17) can be sealed by one or more plates, the plates having the same curve, therefore the same radius, as the mixer vessel.

14. Mixing device according to any of the preceding claims, characterised in that the lower opening stretches substantially along the whole length of the cylindrical vessel (4).

15. Mixing device according to any of the preceding claims, characterised in that the cross-section of the opening is of dimensions that prevent total emptying of the drum from taking place, which would require a bunker located underneath with the same volume as the volume of the ingredients.

16. Mixing device according to any of the preceding claims, characterised in that the cross-section of the opening is variable.

17. Mixing device according to any of the preceding claims, characterised in that the mixing means are able to convey the ingredients in an axial direction.

18. Mixing device according to any of the preceding claims, characterised in that the mixing means are able to convey the ingredients in a radial direction.

19. Mixing device according to any of the preceding claims, characterised in that oblique surfaces are provided on the mixing means which can lead to an axial conveyance of the ingredients as an alternative or in addition.

20. Mixing device according to any of the preceding claims, characterised in that the mixing means have shovels, which formed so that they can throw the ingredients upwards.

21. Mixing device according to any of the preceding claims, characterised in that the mixing means are arranged as a spiral such that they can cause an axial conveyance of the ingredients.

22. Mixing device according to any of the preceding claims, characterised in that the mixing means are formed in such a way that the ingredients can be moved in the direction of a common point.

23. Mixing device according to any of the preceding claims, characterised in that the mixing means have at least two, a maximum of six, preferably three to five, optimally four shovels.

24. Mixing device according to any of the preceding claims, characterised in that the cylindrical vessel (4) is closed at the end face by end walls (3), the vessel and the end walls forming the mixing space.

25. Mixing device according to any of the preceding claims, characterised in that the end walls (3) have a circular cross-section.

26. Mixing device according to any of the preceding claims, characterised in that the end walls (3) have an outwardly conical shape.

27. Mixing device according to any of the preceding claims, characterised in that the end walls (3) are formed as a type of curved plate.

28. Mixing device according to any of the preceding claims, characterised in that the end walls (3) are formed as a type of dished head.

29. Mixing device according to any of the preceding claims, characterised in that the transition of the inner wall of the cylindrical vessel (4) to the inner wall of the end wall (3) extends at an angle greater than 30 degrees and smaller than 90 degrees, preferably greater than 40 degrees and smaller than 60 degrees.

30. Mixing device according to any of the preceding claims, characterised in that one end wall (3) is arranged movably such that it can be brought into two positions, that is into a first position in which the drum (3, 4) is sealed and into a second position in which the interior of the drum (3, 4) is accessible to persons.

31. Mixing device according to any of the preceding claims, characterised in that only one end wall (3) is connected rigidly to the mixing means and the other end wall is movable.

32. Mixing device according to any of the preceding claims, characterised in that the movable end wall (3) is connected to the mixing means in the first position and is separated from the mixing means in the second position.
